(19) United States
(12) Patent Application Publication
(10) Pub. No.: US 2024/0166926 A1
(43) Pub. Date: May 23, 2024

(54) COMPOSITION BASED ON (METH)ACRYLATE MONOMERS

(71) Applicants: BOSTIK SA, COLOMBES (FR); UNIVERSITE DE HAUTE-ALSACE, MULHOUSE CEDEX (FR); CENTRE NATIONAL DE LA RECHERCHE SCIENTIFIQUE, PARIS (FR)

(72) Inventors: Jérôme MAZAJCZYK, Venette (FR); Stéphane FOUQUAY, MONT SAINT AIGNAN (FR); Frédéric SIMON, VENETTE (FR); Guillaume MICHAUD, LYON (FR); Alexis BARRAT, VENETTE (FR); Jacques LALEVEE, MULHOUSE (FR)

(21) Appl. No.: 18/279,233

(22) PCT Filed: Mar. 16, 2022
(86) PCT No.: PCT/FR2022/050473

§ 371 Date: Aug. 29, 2023

(30) Foreign Application Priority Data
Mar. 17, 2021 (FR) FR2102661
May 27, 2021 (FR) FR2105517

(51) Int. Cl. C09J 133/08; B32B 7/12; B32B 17/06; B32B 37/12; C08F 120/28; C09D 133/08

(52) U.S. Cl. CPC C09J 133/08; B32B 7/12; B32B 17/06; B32B 37/12; C08F 120/28; C09D 133/08

(57) ABSTRACT

The present invention relates to a crosslinkable two-component composition comprising:
a component A comprising:
   a compound having the formula (I) below:

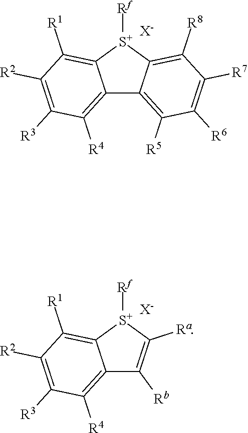

at least one (meth)acrylate monomer M1 having one of the formulae (II), (Ill) or (IV);
a component B comprising at least one compound having the formula (V) below:

R^{c}—SO₂⁻, Q⁺ (V)

and also to the uses thereof.

### FIELD OF THE INVENTION

The present invention relates to a (meth)acrylate-monomer-based composition.

The invention also relates to the use of said composition in the repair and/or the semi- structural or structural adhesive bonding of materials in the transportation, marine, assembly, electronics or construction field.

### TECHNOLOGICAL BACKGROUND

Acrylic compositions are known reactive systems which crosslink by radical polymerization. They are used as adhesives, mastics and coatings. Radical polymerization is typically initiated by a redox system which, by means of an oxidation-reduction reaction, results in the production of radicals.

Most acrylic systems are two-component systems. The first component conventionally contains the reducing agent and the reactive monomers, and the second component contains the oxidizing agent. Once the two components have been mixed, the reducing agent induces cleavage of the O—O bond of the organic peroxide for example, and initiates polymerization.

Typically, (meth)acrylic compositions comprise a peroxide (oxidizing agent)/tertiary amine (reducing agent) redox system. However, these systems may present storage stability problems in the presence of (meth)acrylate monomer.

There is a need for new (meth)acrylic compositions which allow a good compromise between reactivity and storage stability.

In addition, there is also a need for novel (meth)acrylic compositions with good adhesive properties.

### DESCRIPTION OF THE INVENTION

### A. Composition

The present invention relates to a crosslinkable two-component composition comprising:
a component A comprising:
   a compound having one of the following formulae (Ia) or (Ib):

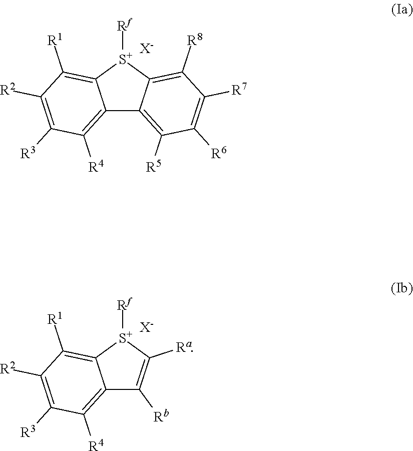

in which:
each one among R¹, R², R¹³, R⁴, R⁵, R⁶, R⁷, R⁸, R^{a} and R^{b} represents, independently of each other, a radical chosen from the group consisting of a hydrogen or halogen atom, alkyl, cycloalkyl or aryl;
Rf represents a perhaloalkyl or a haloalkyl;
X⁻ represents an anion;

and
at least one (meth)acrylate monomer M1 having one of the formulae (II), (Ill) or (IV) below:

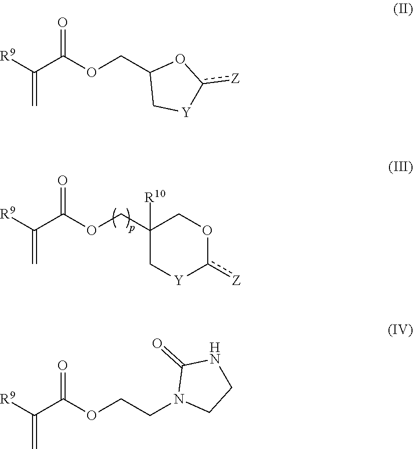

in which:
R⁹ represents H or a methyl;
R¹⁰ represents H, methyl or ethyl;
p represents 0 or 1; and
Z represents H, O, S, an alkyl group, a benzyl group, an aryl group or an alkoxy group;
Y represents O, S, NH or CH₂—;
[symbol] is a single bond or a double bond, on condition that when Z represents 0, then the bond [symbol] is a double bond;
a component B comprising at least one compound having the formula (V) below:

R^{c}—SO₂⁻, Q⁺ (V)

in which:
R^{c} represents a radical chosen from: a heteroaryl, an aryl, an alkyl, said heteroaryl, aryl and alkyl being optionally substituted with at least one of the following radicals: F, OH, C(O)OMe, NHC(O)Me, methyl (Me), CF₃, OH or SO₂⁻;
Q⁺ represents a cation chosen from Li⁺, Na⁺ or K.

In the context of the invention, the term “alkyl” means a linear or branched radical preferably comprising from 1 to 20 carbon atoms. Mention may be made, for example, of methyl, ethyl and propyl.

In the context of the invention, the term “aryl” means a monocyclic or bicyclic aromatic radical preferably comprising from 6 to 12 carbon atoms. Mention may be made, for example, of phenyl.

In the context of the invention, the term “cycloalkyl” means a saturated, monocyclic or polycyclic, preferably monocyclic or bicyclic, system preferably comprising from 3 to 12 carbon atoms, the rings possibly being bridged or fused in pairs, such as the cyclopropyl, cyclopentyl, cyclohexyl or norbornyl groups.

In the context of the invention, the term “alkoxy” means an —O-alkyl radical.

### Component A

### Compound of formula (Ia) or (Ib)

Component A comprises a compound of formula (Ia) or (Ib) as defined above.

The anion ⁻ may be chosen from the group consisting of FSO₃⁻, CF₃SO3, CF₂HSO₃⁻, Cl⁻, Br⁻, BF₄⁻, BF₃Cl⁻ and PF₆⁻.

In the abovementioned formulae (Ia) or (Ib), Rf may represent a haloalkyl. It may, for example, be a fluoroalkyl radical, for instance CHF₂ or CH₂F.

Preferably, in formulae (Ia) or (Ib), Rf represents a perfluoroalkyl, and even more preferentially CF₃, C₂F₅, C₃F₇ or C₄F₉. According to a particularly preferred embodiment, Rf represents CF₃.

The compound of formula (Ia) or (Ib) may be chosen from those in which:
each one among R¹, R², R¹³, R⁴, R⁵, R⁶, R⁷, R⁸, R^{a} and R^{b} represents, independently of each other, a radical chosen from the group consisting of a hydrogen or halogen atom, or an alkyl, preferably a hydrogen or a fluorine atom;
Rf represents a perfluoroalkyl or a fluoroalkyl, preferably a perfluoroalkyl;
X⁻ represents an anion, preferably chosen from FSO₃, CF₃SO₃⁻ and BF₄⁻.

According to a preferred embodiment, component A comprises a compound of formula (Ia), in particular chosen from the group consisting of:

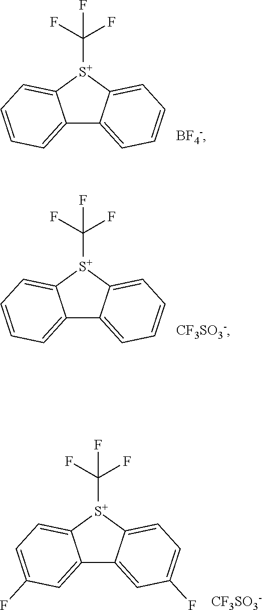

and even more preferentially from one of the following compounds:

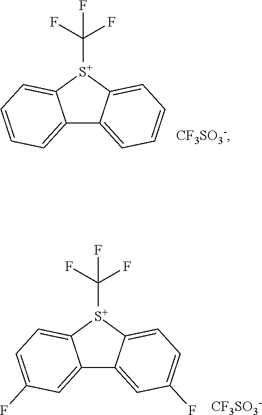

The compounds of formula (Ia) may be prepared as described in WO 2016/107578. The compounds of formula (Ib) may be prepared as described in WO 2011/013307.

The total content of compound(s) of formula (Ia) or (Ib) may range from 0.05% to 5.0% by weight, preferably from 0.1% to 3.0% by weight, even more preferentially from 0.1% to 1.5% by weight relative to the total weight of the crosslinkable two-component composition.

### (Meth)acrylate monomer M1

Component A according to the invention comprises at least one (meth)acrylate monomer M1 having one of the formulae (II), (Ill) or (IV) below:

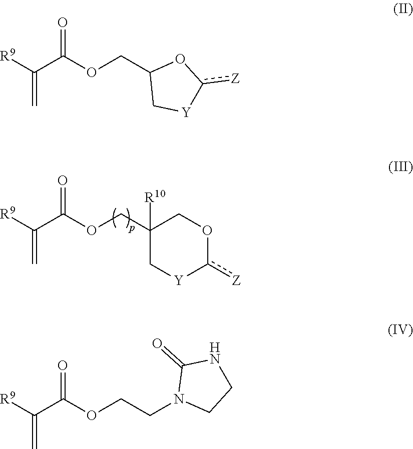

in which:
R⁹ represents H or methyl;
R¹⁰ represents H, methyl or ethyl;
p represents 0 or 1; and
Z represents H, O, S, an alkyl group, a benzyl group, an aryl group or an alkoxy group;
Y represents O, S, NH or CH₂—;
[symbol] is a single bond or a double bond, on condition that when Z represents 0, then the bond [symbol] is a double bond.

The (meth)acrylate monomer M1 may be chosen from the following monomers:

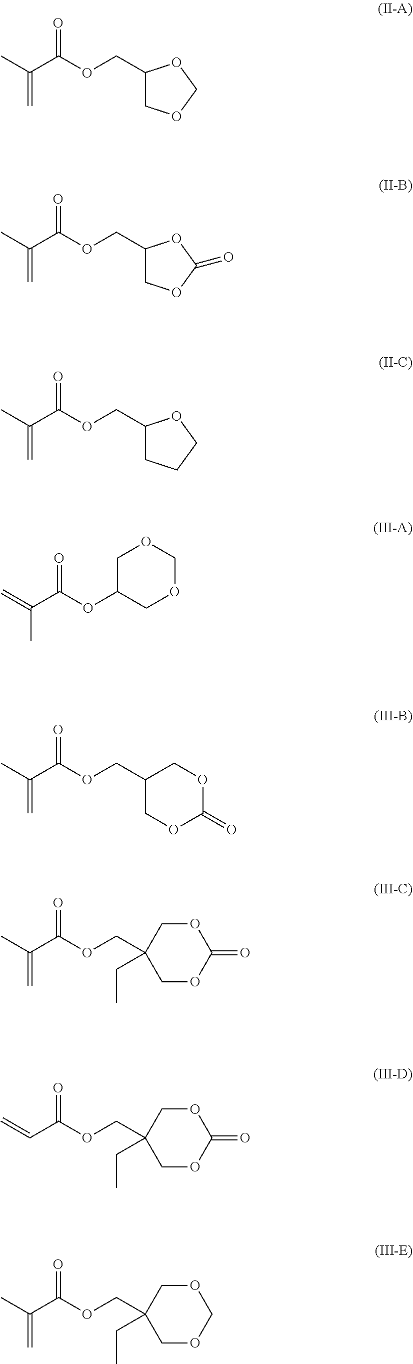

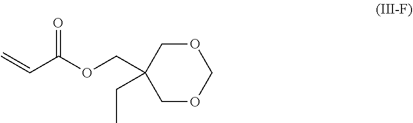

The monomer M1 is preferably chosen from the monomers of formula (II) or (Ill).

It is even more preferentially one of the following compounds or mixtures thereof:

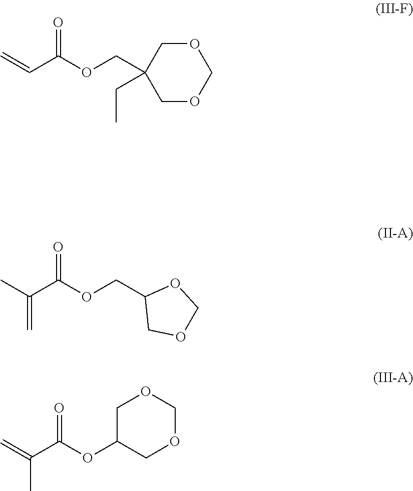

The total content of (meth)acrylate monomer(s) M1 in component A may be greater than or equal to 30% by weight relative to the total weight of said component A.

The content of (meth)acrylate monomer(s) M1 in the crosslinkable two-component composition according to the invention may range from 30% to 99% by weight, preferably from 50% to 99% by weight and even more preferentially from 75% to 99% by weight relative to the total weight of said crosslinkable two-component composition.

### Component B

Component B comprises at least one compound having the formula (V) below:

R^{c}—SO₂⁻, Q⁺ (V)

in which:
R^{c} represents a radical chosen from: a heteroaryl, an arylalkyl, an aryl, an alkyl, said heteroaryl, arylalkyl, aryl and alkyl being optionally substituted with at least one of the following radicals: F, OH, C(O)OMe, NHC(O)Me, methyl (Me), CF₃, OH or SO₂⁻;
Q⁺ represents a cation chosen from Li⁺, Na⁺ or K⁺,

According to a preferred embodiment, the compound of formula (V) is chosen from those for which:
Q⁺ is as defined previously, Q⁺ preferably representing Na⁺ or K⁺, and even more preferentially Na⁺,
R^{c} represents a radical chosen from a heteroaryl or an aryl.

The compound of formula (V) may be chosen from the following compounds:

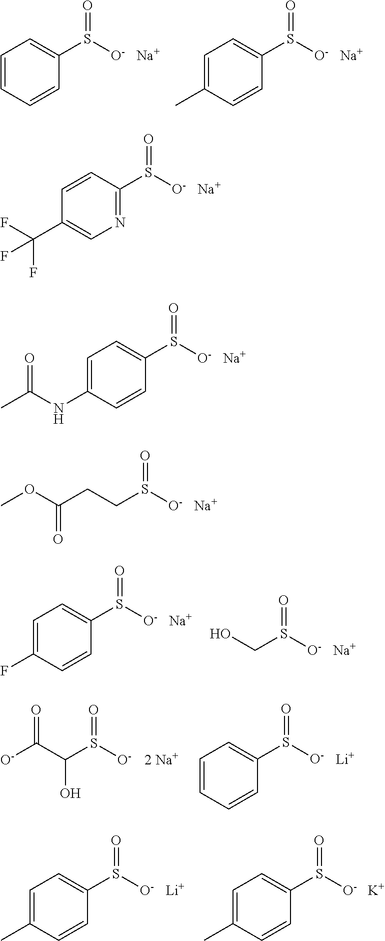

According to a preferred embodiment, the compound of formula (V) is chosen from the following compounds:

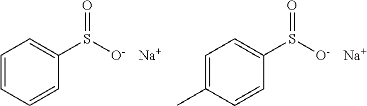

The total content of compound(s) of formula (V) as defined above may range from 0.05% to 5.0% by weight.

The total content by weight of compound(s) of formula (V) as defined above may range from 0.1% to 5.0% by weight, preferably from 0.1% to 3.0% by weight, and even more preferentially from 0.1% to 1.5% by weight, relative to the total weight of the crosslinkable two-component composition according to the invention.

In the crosslinkable two-component composition according to the invention, the compound(s) of formula (I)/compound(s) of formula (V) mole ratio may range from 0.01 to 1.2, preferably from 0.02 to 1.1, preferably from 0.04 to 1.0 and even more preferentially from 0.08 to 0.08.

### Composition

According to a preferred embodiment, the crosslinkable two-component composition does not comprise any peroxide.

Preferably, the two-component composition according to the invention does not comprise any alkyl (meth)acrylate, for instance methyl (meth)acrylate, or benzyl (meth)acrylate.

The crosslinkable two-component composition according to the invention may comprise at least one additive chosen from the group consisting of catalysts, fillers, antioxidants, light stabilizers/UV absorbers, metal deactivators, antistatic agents, film-preventing agents, foaming agents, biocides, plasticizers, lubricants, emulsifiers, dyes, pigments, rheological agents, impact modifiers, adhesion promoters, optical brighteners, flame retardants, anti-sweating agents, nucleating agents, solvents, polymerization inhibitors, and mixtures thereof.

These additives may be present in component A and/or component B of the composition according to the invention.

As examples of plasticizers that may be used, mention may be made of any plasticizer normally used in the field of adhesives, for instance epoxy resins, phthalates, benzoates, trimethylolpropane esters, trimethylolethane esters, trimethylolmethane esters, glycerol esters, pentaerythritol esters, naphthenic mineral oils, adipates, cyclohexyldicarboxylates, paraffinic oils, natural oils (optionally epoxidized), polypropylenes, polybutylenes, hydrogenated polyisoprenes, and mixtures thereof.

Use may be made, for example, of:
diisodecyl phthalate, as sold, for example, under the name Palatinol™ DIDP by the company BASF,
an ester of alkylsulfonic acid and of phenol, as sold, for example, under the name Mesamoll® by the company Lanxess,
diisononyl 1,2-cyclohexanedicarboxylate, as sold, for example, under the name Hexamoll Dinch® by the company BASF,
pentaerythrityl tetravalerate, as sold, for example, under the name PevalenTM by the company Perstorp,
the epoxidized soya bean oil as sold, for example, under the name Vikoflex® 7170 by the company Arkema.

As examples of (thixotropic) rheological agent(s) that may be used, mention may be made of any rheological agent customarily used in the field of adhesive compositions.

Preferably, the thixotropic agents are chosen from:
PVC plastisols, corresponding to a suspension of PVC in a plasticizing agent which is miscible with PVC, obtained in situ by heating to temperatures ranging from 60° C. to 80° C. These plastisols may be those described in particular in the publication Polyurethane Sealants, Robert M. Evans, ISBN 087762-998-6,
fumed silica, as sold, for example, under the name HDK® N20 by Wacker;
urea derivatives resulting from the reaction of an aromatic diisocyanate monomer, such as 4,4′-MDI, with an aliphatic amine, such as butylamine. The preparation of such urea derivatives is described notably in patent application FR 1 591 172;
micronized amide waxes, such as Crayvallac® SLT or Crayvallac® SLA sold by Arkema.

The composition according to the invention may also comprise at least one organic and/or mineral filler.

The mineral filler(s) that may be used are advantageously chosen so as to improve the mechanical performance of the composition according to the invention in the crosslinked state.

As examples of mineral filler(s) that may be used, use may be made of any mineral filler(s) usually used in the field of adhesive compositions. These fillers are typically provided in the form of particles of diverse geometry. They may be, for example, spherical or fibrous or may have an irregular shape.

Preferably, the filler(s) are chosen from the group consisting of clay, quartz, carbonate fillers, kaolin, gypsum, clays and mixtures thereof; preferentially, the filler(s) are chosen from carbonate fillers, such as alkali metal or alkaline-earth metal carbonates, and more preferentially calcium carbonate or chalk.

These fillers may be untreated or treated, for example using an organic acid, such as stearic acid, or a mixture of organic acids predominantly consisting of stearic acid.

Use may also be made of hollow mineral microspheres, such as hollow glass microspheres, and more particularly of those made of calcium sodium borosilicate or of aluminosilicate.

The composition according to the invention may also comprise at least one adhesion promoter, preferably chosen from silanes, such as aminosilanes, epoxysilanes or acryloyl silanes, or adhesion promoters based on a phosphate ester, for instance the 2-hydroxyethyl methacrylate phosphate ester, 2-methacryloyloxyethyl phosphate, bis(2-methacryloyloxyethyl phosphate), 2-acryloyloxyethyl phosphate, bis(2-acryloyloxyethyl phosphate), methyl-(2-methacryloyloxyethyl phosphate), ethyl-(2-methacryloyloxyethyl phosphate), a mixture of 2-hydroxyethyl methacrylate mono- and diphosphate esters.

When a pigment is present in the composition, its content is preferably less than or equal to 3% by weight, more preferably less than or equal to 2% by weight, relative to the total weight of the composition. When it is present, the pigment can, for example, represent from 0.1% to 3% by weight or from 0.4% to 2% by weight relative to the total weight of the composition. The pigments may be organic or inorganic pigments.

For example, the pigment is TiO2, in particular Kronos® 2059 sold by the company Kronos.

As polymerization inhibitor, mention may be made, for example, of 4-hydroxy-2,2,6,6-tetramethylpiperidinoxyl or TEMPOL (CAS: 2226-96-2) sold by the companies BASF and Evonik.

The composition may comprise an amount of from 0.1% to 3%, preferably from 1% to 3%, by weight of at least one UV stabilizer or antioxidant. These compounds are typically introduced in order to protect the composition from degradation resulting from a reaction with oxygen which is liable to be formed by the action of heat or light. These compounds may include primary antioxidants which trap free radicals. The primary antioxidants can be used alone or in combination with other secondary antioxidants or UV stabilizers.

Mention may be made, for example, of Irganox® 1010, Irganox® B561, Irganox® 245, Irgafos® 168, Tinuvin® 328 or TinuvinTM 770, which are sold by BASF.

The crosslinkable two-component composition may also comprise a radical photoinitiator, which may be present in component A and/or component B of the composition. This radical photoinitiator is notably an additional compound to the ingredients of the two-component composition as claimed.

The composition according to the invention may comprise from 0.1% to 5% by weight, preferably from 0.5% to 3% by weight, even more preferentially from 0.5% to 1.5% by weight, of radical photoinitiator(s), relative to the total weight of the composition.

The radical photoinitiator is preferably present in component A.

The radical photoinitiator may be any radical photoinitiator known to those skilled in the art. Under the action of UV/visible radiation, the radical photoinitiator generates radicals which will be responsible for the initiation of the photopolymerization reaction, and makes it possible in particular to increase the efficiency of the photopolymerization reaction. This is, of course, chosen as a function of the light source used, according to its ability to efficiently absorb the radiation selected. It will be possible, for example, to choose the appropriate radical photoinitiator from its UV/visible absorption spectrum. Advantageously, the radical photoinitiator is appropriate for working with irradiation sources emitting in the near zone of the visible region. Advantageously, the source of the UV or visible radiation may be a LED or UVA-centered broad-spectrum lamp of the Delolux 03 S type.

The radical photoinitiator may be chosen from the group consisting of:
type I radical photoinitiators chosen from:
   the family of acetophenones and alkoxyacetophenones, for instance 2,2-dimethoxy-2-phenylacetophenone and 2-diethyl-2-phenylacetophenone;
   the family of hydroxyacetophenones, for instance 2,2-dimethyl-2-hydroxyacetophenone, 1- hyd roxycyclohexyl phenyl ketone, 2- hyd roxy-4′-(2-hydroxyethoxy)-2-methylpropiophenone and 2-hydroxy-4′-(2-hydroxypropoxy)-2-methylpropiophenone;
   the family of alkylaminoacetophenones, for instance 2-methyl-4′-(methylthio)-2-morpholinopropiophenone, 2-benzyl-2-(dimethylamino)-4-morpholinobutyrophenone and 2-(4-methylbenzyl)-2-(dimethylamino)-4-morpholinobutyrophenone;
   the family of benzoin ethers, for instance benzil, benzoin methyl ether and benzoin isopropyl ether;
   the family of phosphine oxides, for instance diphenyl(2,4,6-trimethylbenzoyl)phosphine oxide (TPO), ethyl(2,4,6-trimethylbenzoyl)phenylphosphine oxide (TPO-L) and bis(2,6-dimethoxybenzoyl)-2,4,4-trimethylphenylphosphine oxide (BAPO);
   the family of metallocenes, for instance ferrocene, bis(0-2,4-cyclopentadien-1-yl)bis(2,6-difluoro-3-(1H-pyrrol-1-yl)phenyl)titanium and (cumene)(cyclopentadienyl)iron hexafluorophosphate;
type II radical photoinitiators chosen from:
   the family of benzophenones, for instance 4-phenylbenzophenone, 4-(4′-methylphenylthio)benzophenone or 1-[4-[(4-benzoylphenyl)thio]phenyl]-2-methyl-2-[(4-methylphenyl)sulfonyl]-1-propanone;
   the family of thioxanthones, for instance isopropylthioxanthone (ITX), 2,4-diethylthioxanthone, 2,4-dimethylthioxanthone, 2-chlorothioxanthone and 1-chloro-4-isopropylthioxanthone;
   the family of benzoylformate esters, for instance methyl benzoylformate;
   the family of dibenzylidene ketones, for instance p-dimethylamino ketone;
   the family of coumarins, for instance 5-methoxy- and 7-methoxycoumarin, 7-diethylaminocoumarin and N-phenylglycine coumarin;
radical photoinitiators of the family of dyes, for instance triazines, fluorones, cyanines, safranins, 4,5,6,7-tetrachloro-3′,6′-dihydroxy-2′,4′,5′,7′-tetraiodo-3H-spiro[isobenzofuran-1,9′-xanthen]-3-one, pyryliums and thiopyryliums, thiazines, flavins, pyronines, oxazines or rhodamines;
and mixtures thereof.

Preferably, radical photoinitiator is chosen from the family of phosphine oxides, for instance diphenyl(2,4,6-trimethylbenzoyl)phosphine oxide (TPO), ethyl(2,4,6-trimethylbenzoyl)phenylphosphine oxide (TPO-L) and bis(2,6-dimethoxybenzoyl)-2,4,4-trimethylphenylphosphine oxide (BAPO).

For example, when the source of the UV or visible radiation is an LED, the radical photoinitiator may be chosen from 2,4,6-trimethylbenzoyldiphenylphosphine or TPO available, for example, from Lambson under the commercial reference Speedcure® TPO (CAS: 75980-60-8), ethyl (2,4,6-trimethylbenzoyl)phenylphosphinate or TPO-L available, for example, from Lambson under the commercial reference Speedcure® TPO-L (CAS: 84434-11-7), phenylbis(2,4,6-trimethylbenzoyl)phosphine oxide or BAPO (CAS: 162881-26-7) available, for example, from BASF under the commercial reference Irgacure® 819, 2-benzyl-2-dimethylamino-1-(4-morpholinophenyl)-1-butanone (CAS: 119313-12-1) available, for example, from BASF under the commercial reference Irgacure® 369, 2-methyl-1-[4-(methylthio)phenyl]-2-(4-morpholinyl)-1-propanone (CAS: 71868-10-5) available, for example, from BASF under the commercial reference Irgacure® 907, 1-hydroxycyclohexyl phenyl ketone (CAS: 947-19-3) available, for example, from BASF under the commercial reference Irgacure® 184, 2-isopropylthioxanthone or ITX (CAS: 5495-84-1) available, for example, under the reference Speedcure® 2-ITX, or mixtures thereof.

When the composition according to the invention comprises a radical photoinitiator, the total content of compound(s) of formula (Ia) or (Ib) may range from 0.05% to 5.0% by weight, preferably from 0.05% to 3.0% by weight, more preferably from 0.05% to 1.0% by weight and even more preferentially from 0.05% to 0.5% by weight and the total content of compound(s) of formula (V) may range from 0.05% to 5.0% by weight, preferably from 0.05% to 3.0% by weight, more preferably from 0.05% to 1.0% by weight, and even more preferentially from 0.05% to 0.5% by weight relative to the total weight of the crosslinkable two-component composition according to the invention.

According to a preferred embodiment, the composition according to the invention does not comprise any peroxide.

In the composition according to the invention, the component A/component B volume ratio may range from 20/1 to 1/1, preferentially from 10/1 to 1/1.

### B. Ready-to-Use Kit

The present invention also relates to a ready-to-use kit, comprising both component A as defined above and component B as defined above, packaged in two separate compartments. It may, for example, be a two-component cartridge.

Indeed, the composition according to the invention may be in a two-component form, for example in a ready-to-use kit, comprising both component A in a first compartment or drum and component B in a second compartment or drum, in proportions suitable for direct mixing of the two components, for example using a metering pump.

According to one embodiment of the invention, the kit also comprises one or more means for mixing components A and B. Preferably, the mixing means are chosen from metering pumps or static mixers with a diameter suited to the amounts used.

### C. Uses of the Composition

The present invention also relates to the use of a crosslinkable two-component composition as defined above as adhesive, mastic or coating, preferably as adhesive.

The invention also relates to the use of said composition in the repair and/or the structural or semi-structural adhesive bonding of materials in the transportation, motor vehicle (car, bus or truck), assembly, marine, electronics or construction field.

The present invention relates to a process for assembling two substrates by adhesive bonding, involving:
the coating, onto at least one of the two substrates to be assembled, of a composition obtained by mixing components A and B as defined above; and then
bringing the two substrates into effective contact;
crosslinking the composition.

The crosslinking step may be performed at a temperature of between 0° C. and 200° C., preferably between 10° C. and 150° C., preferably between 23 and 80° C. and in particular between 20° C. and 25° C.

The appropriate substrates are, for example, inorganic substrates, such as concrete, metals or alloys (such as aluminum alloys, steel, non-ferrous metals and galvanized metals); or else organic substrates, such as wood, plastics, such as PVC, polycarbonate, PMMA, polyethylene, polypropylene, polyesters, epoxy resins; substrates made of metal and composites coated with paint.

The crosslinking may be performed under electromagnetic irradiation, for instance with a UV radiation source or an LED.

The crosslinking step under electromagnetic irradiation may be performed at a wavelength greater than 300 nm, preferably ranging from 360 nm to 680 nm, and even more preferentially from 360 nm to 420 nm.

The compositions according to the invention are advantageously stable on storage.

The compositions according to the invention advantageously allow a good compromise between stability on storage and high reactivity.

The compositions according to the invention advantageously have, after crosslinking, good adhesive properties.

In addition, the surface of the crosslinked compositions advantageously dries rapidly and may be tack-free, thereby notably making it possible to increase the productivity of industrial processes.

All the embodiments described above may be combined with each other. In particular, the various abovementioned constituents of the composition, and notably the preferred embodiments of the composition, may be combined with each other.

In the context of the invention, the term “between x and y” or “ranging from x to y” means a range in which the limits x and y are included. For example, the range “between 0% and 25%” notably includes the values 0% and 25%.

The invention is now described in the following implementation examples, which are given purely by way of illustration and should not be interpreted in order to limit the scope thereof.

### EXAMPLES

The following ingredients were used:
SR® 531: cyclic trimethylolpropane formal acrylate (CAS: 66492-51-1) sold by Arkema
Thiophenium I: 5-(trifluoromethyl) dibenzothiophenium, 1,1,1-trifluoromethanesulfonate (CAS: 129946-88-9) available from Sigma-Aldrich
Visiomer Glyfoma (CAS: 1620329-57-8) sold by Evonik
Thiophenium III: 2,8-difluoro-5-trifluoromethyldibenzothiophenium 1,1,1 trifluoromethanesulfonate (CAS: 1961266-44-3) available from TCl chemicals
Sodium toluenesulfinate (CAS: 824-79-3) available from Sigma-Aldrich
Sodium benzenesulfinate (CAS: 873-55-2) available from Sigma-Aldrich
Visiomer benzylmethacrylate (CAS: 2495-37-6) available from Evonik
RETIC™ BP50 available from Luperox (benzoyl peroxide in an isononyl benzoate/ethylene glycol mixture
Bisomer PTE (CAS: 103671-44-9) sold by GEO Specialty Chemicals
Sulfonium: (Difluoromethyl)bis(2,5-dimethylphenyl)sulfonium tetrafluoroborate (CAS: 2133476-51-2) available from TCl

### Example 1: Preparation of Composition 1

The ingredients of component A are mixed in the proportions shown in the following table, at a temperature of 23° C., in a continuously stirred mixer and under nitrogen.
The various ingredients constituting component B are mixed in the proportions shown in the following table, at a temperature of 23° C., in a continuously stirred mixer and under nitrogen.

Composition 1

| Component A | | Component B | |
|---|---|---|---|
| | % by weight | | % by weight |
| | (relative to the | | (relative to the |
| | total weight | | total weight |
| Ingredients | of A) | Ingredients | of B) |
| SR 531 | 98% | SR 531 | 98% |
| Thiophenium I | 2% | Sodium | 2% |
| (CAS: 1961266-44-3) | | toluenesulfinate | |
| TOTAL | 100 | TOTAL | 100 |

Component A and component B are mixed, in a 1:1 volume ratio using a Sulzer® Mixpac mixer at an ambient temperature of 23° C.

### Example 2: Preparation of Composition 2

The ingredients of component A are mixed in the proportions shown in the following table, at a temperature of 23° C., in a continuously stirred mixer and under nitrogen.

The various ingredients constituting component B are mixed in the proportions shown in the following table, at a temperature of 23° C., in a continuously stirred mixer and under nitrogen.

Composition 2

| Component A | | Component B | |
|---|---|---|---|
| | % by weight | | % by weight |
| | (relative to the | | (relative to the |
| | total weight | | total weight |
| Ingredients | of A) | Ingredients | of B) |
| Glyfoma | 98% | Glyfoma | 98% |
| Thiophenium III | 2% | Sodium | 2% |
| (CAS: 129946-88-9) | | toluenesulfinate | |
| TOTAL | 100 | TOTAL | 100 |

Component A and component B are mixed, in a 1:1 volume ratio using a Sulzer® Mixpac mixer at an ambient temperature of 23° C.

### Example 3: Preparation of Composition 3

The ingredients of component A are mixed in the proportions shown in the following table, at a temperature of 23° C., in a continuously stirred mixer and under nitrogen.

The various ingredients constituting component B are mixed in the proportions shown in the following table, at a temperature of 23° C., in a continuously stirred mixer and under nitrogen.

Composition 3

| Component A | | Component B | |
|---|---|---|---|
| | % by weight | | % by weight |
| | (relative to the | | (relative to the |
| | total weight | | total weight |
| Ingredients | of A) | Ingredients | of B) |
| SR 531 | 98% | SR 531 | 98% |
| Thiophenium III | 2% | Sodium | 2% |
| (CAS: 129946-88-9) | | benzenesulfinate | |
| TOTAL | 100 | TOTAL | 100 |

Component A and component B are mixed, in a 1:1 volume ratio using a Sulzer® Mixpac mixer at an ambient temperature of 23° C.

### Example 4: Preparation of Composition 4 (Comparative Example)

The ingredients of component A are mixed in the proportions shown in the following table, at a temperature of 23° C., in a continuously stirred mixer and under nitrogen.

The various ingredients constituting component B are mixed in the proportions shown in the following table, at a temperature of 23° C., in a continuously stirred mixer and under nitrogen.

Composition 4 (comparative)

| Component A | | Component B | |
|---|---|---|---|
| | % by weight | | % by weight |
| | (relative to the | | (relative to the |
| | total weight | | total weight |
| Ingredients | of A) | Ingredients | of B) |
| Benzyl methacrylate | 98% | Benzyl | 98% |
| | | methacrylate | |
| Thiophenium III | 2% | Sodium | 2% |
| (CAS 129946-88-9) | | benzenesulfinate | |
| TOTAL | 100 | TOTAL | 100 |

Component A and component B are mixed, in a 1:1 volume ratio using a Sulzer® Mixpac mixer at an ambient temperature of 23° C.

### Example 5: Preparation of Composition 5 (Comparative Example)

The ingredients of component A are mixed in the proportions shown in the following table, at a temperature of 23° C., in a continuously stirred mixer and under nitrogen.

The various ingredients constituting component B are mixed in the proportions shown in the following table, at a temperature of 23° C., in a continuously stirred mixer and under nitrogen.

Composition 5 (comparative)

| Component A | | Component B | |
|---|---|---|---|
| | % by weight | | % by weight |
| | (relative to the | | (relative to the |
| | total weight | | total weight |
| Ingredients | of A) | Ingredients | of B) |
| SR 531 | 98% | SR 531 | 98% |
| Sulfonium (CAS | 2% | Sodium | 2% |
| 2133476-51-2) | | benzenesulfinate | |
| TOTAL | 100 | TOTAL | 100 |

Component A and component B are mixed, in a 1:1 volume ratio using a Sulzer® Mixpac mixer at an ambient temperature of 23° C.

### Example 6: Preparation of Composition 6 (Comparative Example)

The ingredients of component A are mixed in the proportions shown in the following table, at a temperature of 23° C., in a continuously stirred mixer and under nitrogen.

The various ingredients constituting component B are mixed in the proportions shown in the following table, at a temperature of 23° C., in a continuously stirred mixer and under nitrogen.

Composition 6 (comparative)

| Component A | | Component B | |
|---|---|---|---|
| | % by weight | | % by weight |
| | (relative to the | | (relative to the |
| | total weight | | total weight |
| Ingredients | of A) | Ingredients | of B) |
| Glyfoma | 99% | Glyfoma | 99% |
| Bisomer PTE | 1% | Retic BP 50 | 1% |
| TOTAL | 100 | TOTAL | 100 |

Component A and component B are mixed, in a 1:1 volume ratio using a Sulzer® Mixpac mixer at an ambient temperature of 23° C.

### Example 7: Performance of the Compositions

The adhesive bonding tests were performed under the following conditions:
Application of compositions 1, 2, 3, 4, 5 and 6 (obtained, respectively, in Examples 1, 2, 3, 4, 5 and 6 by mixing components A and B using a Sulzer® Mixpac mixer) on a first glass microscope slide (25×76 mm);
Affixing a second glass microscope slide (25×76 mm) onto the first slide which received compositions 1, 2, 3, 4, 5 and 6;
Step of sliding the two microscope slides to enable equal distribution of compositions 1, 2, 3, 4, 5 and 6 between the two slides (the oxygen exposure is reduced here).

The time at which point it is no longer possible to separate the two slides is recorded.

The reactivity (exotherm) is analyzed continuously using a pyrometer and by thermal imaging. The gel time (or lag time) is the time it takes for the sample to start polymerizing.

The time/temperature profiles were produced using an Omega 05552-V1-6 industrial infrared thermometer (Omega Engineering®, Inc., Stamford, CT) accurate to ±1° C. for 2 g (about 4.0 mm height) and 0.25 g (1.4 mm height) of polymerization.

The results are collated in the following table:

| | | | | Adhesive | | |
|---|---|---|---|---|---|---|
| | | | | bonding time | | |
| | | Temperature | | for a thickness | | |
| Composition | Gel time (s) | peak (in ° C.) | | of 300 microns | | Comments |
| Composition 1 | 48 | 130° | C. | 3 | minutes | No tack |
| (Example 1) | | | | | | |
| Composition 2 | 180 | 88° | C. | 7 | minutes | No tack |
| (Example 2) | | | | | | |
| Composition 3 | 60 | 90° | C. | 2 | minutes | No tack |
| (Example 3) | | | | | | |
| Composition 4 | No | NP | | NP | | — |
| (comparative example | Polymerization | | | | | |
| 4) | (NP) | | | | | |
| Composition 5 | No | NP | | NP | | — |
| (comparative example | Polymerization | | | | | |
| 5) | (NP) | | | | | |
| Composition 6 | 246 | 91° | C. | 10 | min | No tack |

| | |
|---|---|
| (comparative example | but part B |
| 6) | unstable |

As emerges from this table, compositions 1, 2 and 3 (according to the invention) advantageously polymerize quickly (after mixing components A and B), in view of their short gel times (48, 180 and 60 seconds, respectively). On the other hand, it was observed that the comparative compositions 4 and 5 (Examples 4 and 5) do not polymerize in the open air. Composition 6 does polymerize, but, unlike the parts B of Examples 1, 2 and 3, part B is unstable over time (24 h) and polymerizes, making composition 6 unusable in practice for a commercial product. Furthermore, the comparative composition 6 results in a long gel time: 246 s relative to compositions 1, 2 and 3 according to the invention.

Also, compositions 1, 2 and 3 advantageously lead to adhesive bonding with fast setting times, compared with composition 4, which does not allow bonding.

Finally, it was observed that the polymer obtained after crosslinking is advantageously surface dry (no tack) for compositions 1 (Example 1) and 2 (Example 2) and 3 (Example 3).

1-15. (canceled)

16. A crosslinkable two-component composition comprising:
a component A comprising:
a compound having one of the following formulae (Ia) or (Ib): 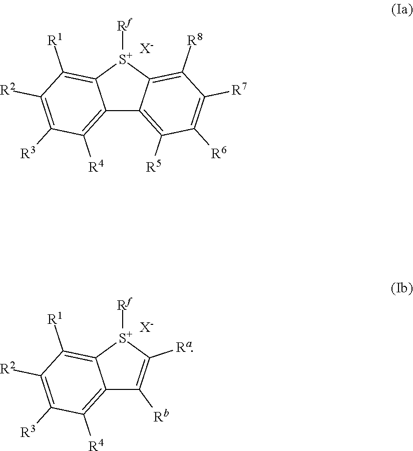
in which:
each one among R¹, R², R¹³, R⁴, R⁵, R⁶, R⁷, R⁸, R^{a} and R^{b} represents, independently of each other, a radical chosen from the group consisting of a hydrogen or halogen atom, alkyl, cycloalkyl or aryl;
Rf represents a perhaloalkyl or a haloalkyl;
X⁻ represents an anion;
and
at least one (meth)acrylate monomer M1 having one of the formulae (II), (III) or (IV) below: 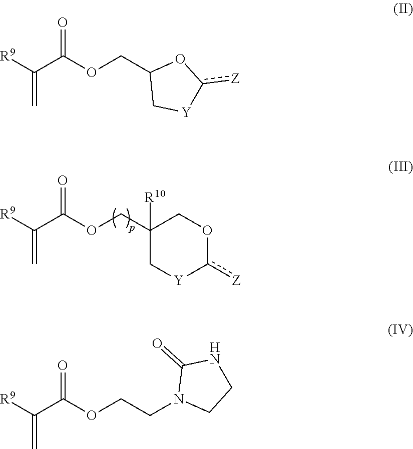
in which:
R⁹ represents H or a methyl;
R¹⁰ represents H, methyl or ethyl;
p represents 0 or 1; and
Z represents H, O, S, an alkyl group, a benzyl group, an aryl group or an alkoxy group;
Y represents O, S, NH or CH₂—; [symbol]
is a single bond or a double bond, on condition that when Z represents 0, then the bond [symbol] is a double bond;
a component B comprising at least one compound having the formula (V) below:
R^{c}—-SO₂⁻, Q⁺ (V)
in which:
R^{c} represents a radical chosen from: a heteroaryl, an aryl, an alkyl, said heteroaryl, aryl and alkyl being optionally substituted with at least one of the following radicals: F, OH, C(O)OMe, NHC(O)Me, methyl (Me), CF₃, OH or SO₂⁻; and
Q⁺ represents a cation chosen from Li⁺, Na⁺ or K⁺.

17. The composition as claimed in claim 16, characterized in that, in formula (Ia) or (Ib), the anion X⁻ is chosen from the group consisting of FSO₃⁻, CF₃SO₃⁻, CF₂HSO₃⁻, Cl⁻, Br⁻, BF₄⁻, BF₃Cl⁻ and PF₆⁻.

18. The composition as claimed in claim 16, characterized in that, in formula (Ia) or (Tb):
each one among R¹, R², R¹³, R⁴, R⁵, R⁶, R⁷, R⁸, R^{a} and R^{b} represents, independently of each other, a radical chosen from the group consisting of a hydrogen or halogen atom, or an alkyl;
Rf represents a perfluoroalkyl or a fluoroalkyl; and
X⁻ represents an anion.

19. The composition as claimed in claim 16, characterized in that the compound of formula (Ia) is chosen from the group consisting of:

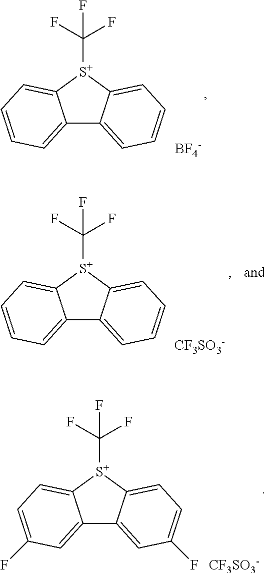

20. The composition as claimed in claim 16, in which the total content of compound(s) of formula (Ia) or (Ib) ranges from 0.05% to 5.0% by weight, relative to the total weight of said crosslinkable two-component composition.

21. The composition as claimed in claim 16, characterized in that the (meth)acrylate monomer M1 is chosen from the following monomers:

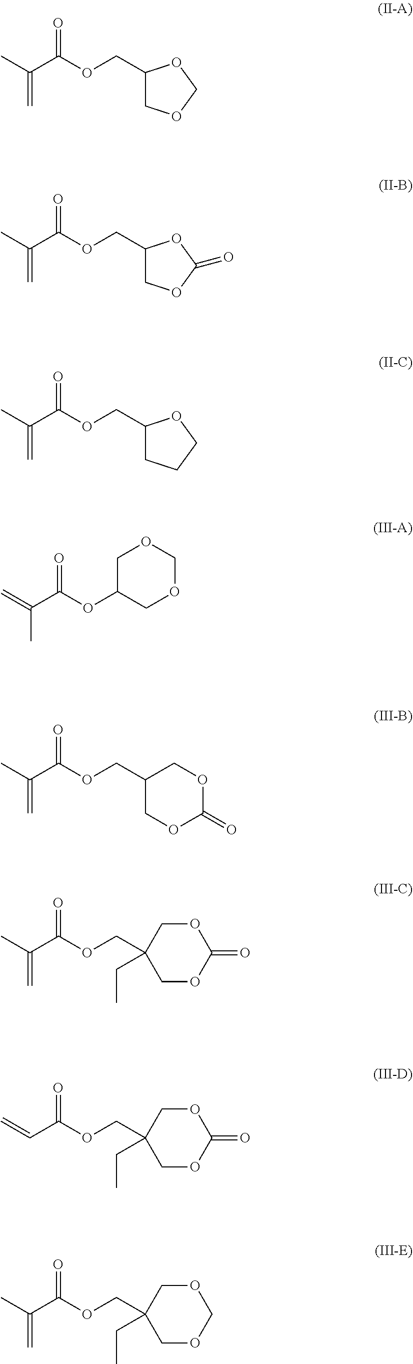

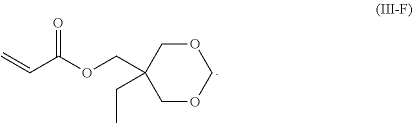

22. The composition as claimed in claim 16, characterized in that the total content of (meth)acrylate monomer(s) M1 ranges from 30% to 99% by weight, relative to the total weight of said crosslinkable two-component composition.

23. The composition as claimed in claim 16, characterized in that the compound of formula (V) is chosen from those for which RC represents a radical chosen from heteroaryl or aryl.

24. The composition as claimed in claim 16, characterized in that the compound of formula (V) is chosen from the following compounds:

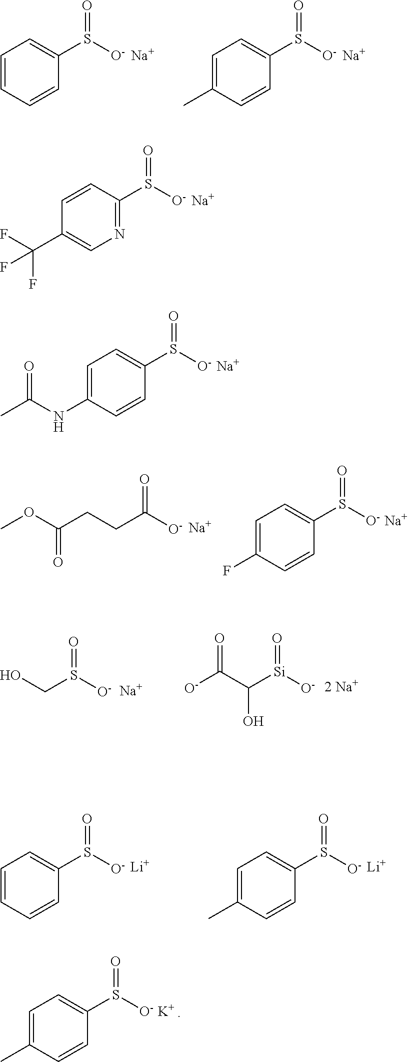

25. The composition as claimed in claim 16, characterized in that the compound of formula (V) is chosen from the following compounds:

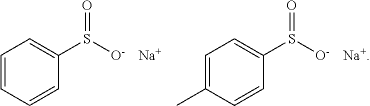

26. The composition as claimed in claim 16, characterized in that the total content of compound(s) of formula (V) ranges from 0.1% to 5.0% by weight, relative to the total weight of said crosslinkable two-component composition.

27. The composition as claimed in claim 16, characterized in that it does not comprise any peroxide.

28. The composition as claimed in claim 16, characterized in that it also comprises a radical photoinitiator.

29. An adhesive, mastic or coating comprising the composition of claim 16.

30. A process for assembling two substrates by adhesive bonding, comprising:
the coating, onto at least one of the two substrates to be assembled, of a composition obtained by mixing components A and B as defined in claim 16; and then
bringing the two substrates into effective contact; and
crosslinking the composition.
